(19) United States
(12) Patent Application Publication
(10) Pub. No.: US 2024/0384085 A1
(43) Pub. Date: Nov. 21, 2024

(54) COMPOSTABLE PLASTICIZED POLYVINYL CHLORIDE COMPOSITIONS AND RELATED METHODS

(71) Applicant: Singular Solutions Inc., North York (CA)

(72) Inventors: Mirek Planeta, Mississauga (CA); Alex Mann, Vaughan (CA); Vladimir Climov, Toronto (CA)

(21) Appl. No.: 18/695,894

(22) PCT Filed: Sep. 30, 2022
(86) PCT No.: PCT/CA2022/051458

§ 371 Date: Mar. 27, 2024

Related U.S. Application Data
(60) Provisional application No. 63/250,385, filed on Sep. 30, 2021.

(51) Int. Cl. C08L 27/06

(52) U.S. Cl. CPC C08L 27/06; C08L 2205/035

(57) ABSTRACT

Compostable plasticized polyvinyl chloride (PVC) compositions and related methods with a liquid preparation including a nanostarch compound, and a solid appetizer material. The addition of mechanically and chemically modified nanostarch and its derivatives, biodegradable plastics, polysaccharides, and/or other microbe-edible substances to traditional, non-biodegradable plasticized polyvinyl chloride (PVC) compositions can make this material biodegradable. The speed of biodegradation can be accelerated by incorporating a binary system of a liquid nanostarch preparation and a solid appetizer into plasticized PVC compositions.

### CROSS-REFERENCE TO RELATED APPLICATION

This application claims priority to U.S. Provisional Application No. 63/250,385 filed on Sep. 30, 2021, the entire contents of which are hereby incorporated herein by reference.

### FIELD

The present disclosure relates generally to biodegradable and compostable plasticized polyvinyl chloride compositions.

### BACKGROUND

The following paragraphs are not an admission that anything discussed in them is prior art or part of the knowledge of persons skilled in the art.

U.S. Pat. No. 5,844,023 describes a biologically degradable polymer mixture which consists essentially of starch and at least one hydrophobic polymer. The hydrophobic polymer is in this connection at least substantially biologically degradable and thermoplastically processable and the mixture with the starch comprising a polymer phase mediator or a macromolecular dispersing agent so that the starch is present in the mixture as disperse phase with the hydrophobic polymer as continuous phase, and the phase mediator or the dispersing agent is responsible for the molecular coupling of the two phases. As starch there is preferably used thermoplastic starch which has been prepared substantially with the exclusion of water by means of sorbitol or glycerol. The production of the biologically degradable polymer mixture is also carried out substantially with the exclusion of water.

U.S. Pat. No. 8,067,485 B2 describes a method of preparing a biodegradable polymer composition, said method comprising melt mixing a first biodegradable polyester and a masterbatch, wherein said masterbatch has been formed separately by melt mixing in the presence of a transesterification catalyst a polysaccharide, a second biodegradable polyester and a biodegradable polymer having pendant carboxylic acid groups.

United States Publication No. 2018/0334564 A1 describes biodegradable compositions of polybutylene-succinate (PBS) or polybutylene-succinate-adipate (PBS A) with biobased 3-hydroxybutyrate copolymers are described. In certain embodiments, the copolymer increases the biodegradation rate of the PBS or PBSA. Methods of making the compositions of the invention are also described. The invention also includes articles, films and laminates comprising the compositions.

U.S. Pat. No. 11,111,355 B2 describes methods for rendering biodegradable a plastic material that is not itself biodegradable, by blending the plastic material with a carbohydrate-based polymeric material that is formed from a) one or more starches and a plasticizer (e.g., glycerin), b) an additive known in the art as an OXO material and/or an additive that interacts with microbes that contribute to biodegradation of the non-biodegradable material. The carbohydrate-based polymeric material is less crystalline than the non-biodegradable mate-rials, e.g., being substantially amorphous, and having a crystallinity of no more than 20%. When tested under conditions causing biodegradation, the blend biodegrades to an extent greater than the content of the carbohydrate-based polymer.

### INTRODUCTION

The following is intended to introduce the reader to various aspects of the present disclosure, but not to define any invention.

In an aspect of the present disclosure, a compostable plasticized polyvinyl chloride (PVC) composition may include: a liquid preparation including a nanostarch compound; and a solid appetizer material.

In an aspect of the present disclosure, a method of preparing a biodegradable polyvinyl chloride (PVC) material may include: providing a liquid preparation including a nanostarch compound; providing a solid appetizer material; providing a PVC resin; dryblending the liquid preparation, the solid appetizer material and the PVC resin to form a PVC composition; and extruding the PVC composition to obtain the biodegradable plastic material.

### BRIEF DESCRIPTION OF THE DRAWINGS

The drawings included herewith are for illustrating various examples of apparatuses and methods of the present disclosure and are not intended to limit the scope of what is taught in any way. In the drawings:

FIGS. 1 to 5 are schematic diagrams of a compostable PVC composition, illustrating progressive biodegradation; and

FIG. 6 is a graph of biodegradation of exemplary PVC film over 150 days in simulated aerobic composting conditions according to ASTM D5338.

### DESCRIPTION

Various compositions and methods will be described below to provide an example of an embodiment of each claimed invention. No embodiment described below limits any claimed invention and any claimed invention may cover compositions or methods that differ from those described below. The claimed inventions are not limited to compositions and methods having all of the features of any one composition or method described below or to features common to multiple or all of the compositions and methods described below. It is possible that a composition or a method described below is not an embodiment of any claimed invention. Any invention disclosed below that is not claimed in this document may be the subject matter of another protective instrument, for example, a continuing patent application, and the applicants, inventors, or owners do not intend to abandon, disclaim, or dedicate to the public any such invention by its disclosure in this document.

The addition of starch, sugar and other microbe-edible substances into biodegradable plastics can improve their biodegradability by increasing bacterial insemination rate, due to the fact that those substances present naturally available feedstock for bacteria and thus serve as an appetizer for bacteria while being dispersed within the biodegradable plastic matrix. The present disclosure relates to the discovery that the addition of mechanically and chemically modified nanostarch and its derivatives, biodegradable plastics, polysaccharides, and/or other microbe-edible substances to traditional, non-biodegradable plasticized polyvinyl chloride (PVC) compositions can make this material biodegradable, yet its biodegradation rate can be significantly slower than for inherently biodegradable polymers. The present disclosure further relates to accelerating the speed of biodegradation by incorporating a binary system of a liquid nanostarch preparation and a solid appetizer into plasticized PVC compositions. The liquid preparation is referred to herein as a biodegradation “booster” and can consist of a nanostarch compound dissolved in a plasticizer, prior to dryblending with the PVC composition. The nanostarch compound can consist of mechanically and chemically modified nanostarch, small and large particle size starches, and/or their chemically modified derivatives. The solid appetizer can consist of biodegradable plastics, polysaccharides, and/or other microbe-edible substances. The ingredients of the liquid nanostarch booster and the solid appetizer can be selected to match chemical and physical properties of the plasticized PVC composition and methods of its manufacturing. This discovery offers a means of replacing traditional, non-biodegradable plasticized PVC compositions with similarly performing biodegradable plasticized PVC compositions, which can be eaten by bacteria and converted into humus, water and carbon dioxide, once exposed to moisture and bacteria in composting facilities and/or in nature after their use cycle.

Inherently biodegradable plastics (sometimes called bioplastics) can be made either by bacterial fermentation from natural foods (like cornstarch and similar) or synthesized from gas and crude oil byproducts. Such bioplastics include poly (butylene adipate) (PBA), poly (butylene adipate-co-butylene terephthalate) (PBAT), poly (butylene succinate) (PBS), poly (butylene succinate-co-butylene adipate) (PBSA), poly (butylene terephthalate) (PBT), polyhydroxybutyrate (PHB), polyhydroxy-butylhexanoate (PHBH), polydioxanone (PDO), poly (glycolic acid) (PGA), poly (vinyl alcohol) (PVOH), polylactic acid (PLA), poly-epsiloncaprolactone (PCL), poly (limonene carbonate) (PLC), polyhydroxyalkanoate (PHA), polyhydroxyvalerate (PHV), polyhydroxy-butyratevalerate (PHBV), and other biodegradable polymers known to persons skilled in the art. These bioplastics are generally distinct from regular plastics because their monomers and the bioplastics themselves are readily edible by bacteria.

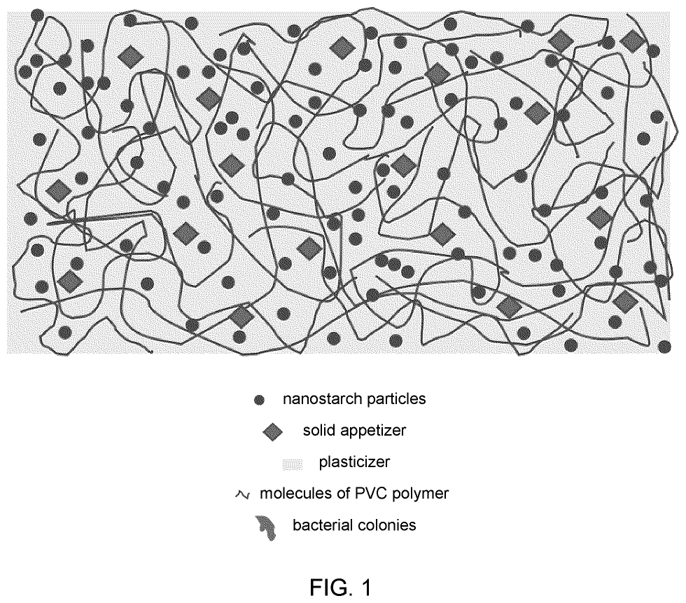

Referring to FIG. 1, a PVC composition includes nanostarch particles, solid appetizer material, plasticizer, and molecules of the PVC polymer.

It should be appreciated that regular plasticized PVC plastics generally cannot be directly eaten by bacteria. Plasticized PVC plastic formulated with a binary system of liquid nanostarch booster and solid appetizer described herein undergoes a four-step biodegradation process.

Firstly, during the initial three days after extrusion of plasticized PVC, its microstructure settles, promoting migration of the liquid nanostarch booster to the surface of the extruded PVC item. This is shown in FIG. 2.

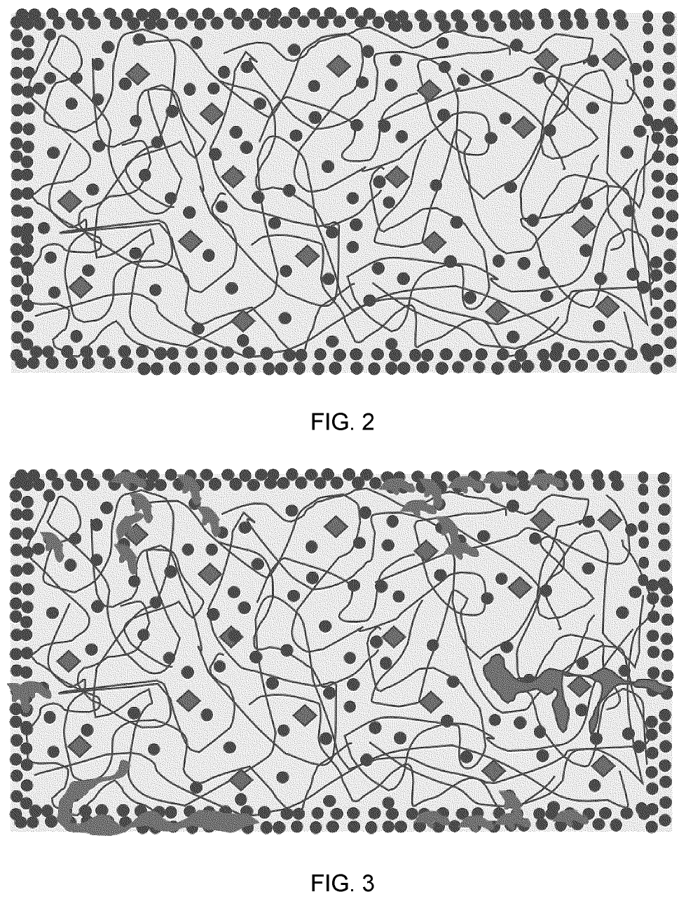

Secondly, microbe-edible liquid nanostarch booster appetizes and initiates bacterial insemination, which promptly spreads over the surface and channels into the bulk of the PVC film via components of liquid nanostarch booster interspaced with macromolecules of PVC resin, thus increasing the amount of the material exposed to bacteria. This is shown in FIG. 3.

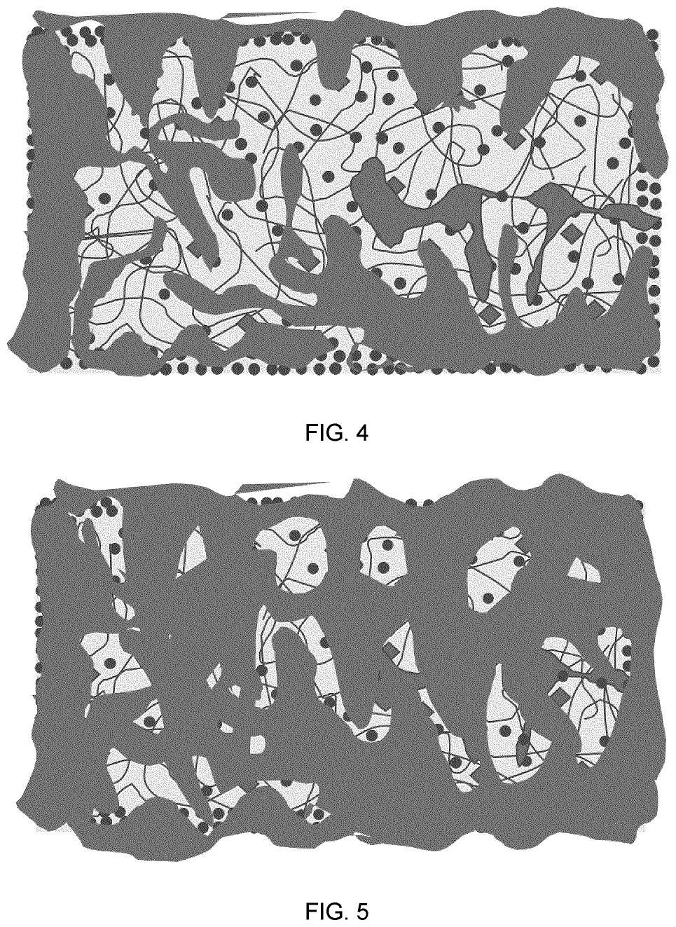

Thirdly, solid appetizer further supports bacterial insemination and colonization, which yields ferments and/or enzymes able to decompose the surrounding PVC resin into substances also edible by microbes. This is shown in FIG. 4.

Lastly, bacterial attack progresses, with the surrounding regular plastic decomposed into bacteria-edible substances that are consumed as well. This is shown in FIG. 5.

The entire process is purely chemotactic, and, in contrast to chemical oxo-degradation processes, avoids the creation of microplastics. The plastic article can stay intact while eaten by bacteria. As the biodegradation progresses, the plastic article disintegrates into smaller debris, each carrying substantial bacterial insemination load sufficient for furthering the biodegradation to completion. The process can initiate only after the PVC plastic is discarded into the environment or placed into a composting facility. Until then, it can have a practically unlimited shelf-life and can be fully re-processable and recyclable.

Thus, in accordance with an aspect of the present disclosure, a solid appetizer can include a biodegradable polymer as a carrier polymer. The biodegradable polymer can be selected from PBA, PBAT, PBS, PBSA, PBT, PHB, PHBH, PDO, PGA, PVOH, PLA, PCL, PLC, PHA, PHV, PHBV, other biodegradable polymers known to persons skilled in the art, and mixtures thereof. In some examples, the solid appetizer can include about 30% w/w to about 80% w/w of the biodegradable polymer. In some examples, the solid appetizer can include about 50% w/w to about 70% w/w of the biodegradable polymer. In some examples, the solid appetizer can include about 60% w/w of the biodegradable polymer.

Alternatively, a solid appetizer can include a non-biodegradable PVC polymer as a carrier polymer. In some examples, a solid appetizer can include both biodegradable and non-biodegradable polymers.

In some exemplary experiments, the inventors prepared PVC compositions with additions of starch to plasticizer. Regular starch can be unstable during typical extrusion conditions, and can be characterized by a limited specific surface area of particles, and a limited compatibility with various plasticizers used in PVC compositions, including, for example but not limited to, epoxidized soya bean oil (ESBO), dinormalhexyl phthalate (DnHP), diisoheptyl phthalate (DIHP), diheptyl phthalate (DnHP), di (2-ethylhexyl) phthalate (DEHP), diheptylnonyl phthalate (DnHNP), dinormaloctyldecyl phthalate (DNODP), diheptylnonylundecyl phthalate (DnHNUP), diisononyl phthalate (DINP), dinonyl phthalate (DNP), dinormalnonyl phthalate (DnNP), diisodecyl phthalate (DIDP), dinormalnonyldecylundecyl phthalate (DnNDUP), dinonylundecyl phthalate (DnNUP), diundecyl phthalate (DUP), diisoundecyldodecyl phthalate (DUDP), ditridecyl phthalate (DTDP), di (2-ethylhexyl) teraphthalate (DOTP), butylbenzyl phthalate (BBP), dioctyl adipate (DOA), diheptylnonyl adipate (DnHNA), Di (2-ethylhexyl) adipate (DEHA), diisononyl adipate (DINA), diisodecyl adipate (DIDA), triheptylnonyl trimellitate (TnHNTM), tri (2-ethylhexyl) trimellitate (TOTM), triisononyl trimellitate (TINTM), di (2-ethylhexyl) sebacate (DOS), di (2-ethylhexyl) azelate (DOZ), mixtures thereof, and other plasticizers known to persons skilled in the art.

The inventors focused on a nanostarch compound containing 100 nm nanostarch produced via a process of mechanical destruction of regular starch, and then capping and partially cross-linking the nanostarch particles with maleic anhydride in a reactive extrusion process for improved thermal stability and compatibility with typical PVC plasticizers. In some examples, a liquid nanostarch booster can consist of the nanostarch compound dissolved in a plasticizer, and include dehydrated small-particle starch, for example, waxy rice starch with a particle size in a range of about 2 to about 13 μm, and large-particle starch, for example, potato starch with a particle size in a range of about 10 to about 70 μm. In other examples, a liquid nanostarch booster can consist of only maleated nanostarch dissolved in a plasticizer, while a solid appetizer can contain dehydrated small-particle starch, for example, waxy rice starch with a particle size in a range of about 2 to about 13 μm, and large-particle starch, for example, potato starch with a particle size in a range of about 10 to about 70 μm.

Table 1 shows the sizes of various typical natural starches.

TABLE 1
Granule Size of Various Starches

| | Granule Size Range (μm) | Average size |
|---|---|---|
| Starch Species | (Coulter Counter) | (μm) |
| Waxy Rice | 2-13 | 5.5 |
| High Amylose Corn | 4-22 | 9.8 |
| Corn | 5-25 | 14.3 |
| Cassava | 3-28 | 14 |
| Sorghum | 3-27 | 16 |
| Wheat | 3-34 | 6.5, 19.5 |
| Sweet Potato | 4-40 | 18.5 |
| Arrowroot | 9-40 | 23 |
| Sago | 15-50 | 33 |
| Potato | 10-70 | 36 |
| Canna (Aust. Arrowroot) | 22-85 | 53 |

A comparison of these sizes shows that, for example, 1% of 100 nm nanostarch compared to 20.8 μm regular starch increases a total specific surface area of starch by an average factor of 208. Exemplary calculations are given in Table 2.

TABLE 2

| | |
|---|---|
| startch | nano-startch |

Largest startch of 85 microns

| | | |
|---|---|---|
| size, mic | 85 | 0.1 |
| density, gr/cc | 1.5 | 1.5 |
| particle weight, gr | 9.2119E−07 | 1.5E−15 |
| # of particles per gr | 1085555.33 | 6.6667E+14 |
| particle surface area, cm2 | 0.00090746 | 1.256E−09 |
| specific surface are per 1 gr, cm2 | 985.098039 | 837333.333 |
| relative surface area | 1 | 850 |

Average size of 12 known types of starch - 20.8 microns

| | | |
|---|---|---|
| size, mic | 20.8 | 0.1 |
| density, gr/cc | 1.5 | 1.5 |
| particle weight, gr | 1.3498E−08 | 1.5E−15 |
| # of particles per gr | 74083029.9 | 6.6667E+14 |
| particle surface area, cm2 | 5.434E−05 | 1.256E−09 |
| specific surface are per 1 gr, cm2 | 4025.64103 | 837333.333 |
| relative surface area | 1 | 208 |

Smallest startch of 2 microns

| | | |
|---|---|---|
| size, mic | 2 | 0.1 |
| density, gr/cc | 1.5 | 1.5 |
| particle weight, gr | 1.2E−11 | 1.5E−15 |
| # of particles per gr | 8.3333E+10 | 6.6667E+14 |
| particle surface area, cm2 | 5.024E−07 | 1.256E−09 |
| specific surface are per 1 gr, cm2 | 41866.6667 | 837333.333 |
| relative surface area | 1 | 20 |

Due to such an increase in surface area, the rate of initial bacterial insemination and colonization increases drastically. Hence, nanostarch can serve for fast onset of the biodegradation process, while regular starch can present feedstock for retaining bacterial colonies long enough to modify and then eat regular plastic.

In some examples, a liquid nanostarch booster and a solid appetizer can include three elements: 100 nm nanostarch for increasing specific surface area exposed to bacteria to speed up the rate of initial bacterial insemination; small regular starch, for example, waxy rice starch with a particle size in a range of about 2 to about 13 μm, which provides feedstock for developing bacterial colonies; and large regular starch, for example, potato starch with a particle size in a range of about 10 to about 70 μm, which provides enough feedstock for long-term development of bacterial colonies.

In some examples, described herein, nanostarch and starch can be combined with monosaccharides like sucrose, sorbitol, etc., to further speed-up the initial bacterial insemination. The choice of specific type of monosaccharide and its content, as well as content and ratio of starches in a liquid nanostarch booster and a solid appetizer is specific to the specific plasticizer used, the degree of plasticization of PVC composition, extrusion process parameters, and end-use product specifications. In addition to nanostarch, the solid appetizer may contain monosaccharides and can be melt mixed with a matrix of biodegradable carrier plastics like PBAT, PLA, PBS, PHA, PCL, etc., which serve as a feedstock for bacteria, and allow good dispersion of ingredients of solid appetizer in PVC plastic. In some examples, the liquid nanostarch booster and a solid appetizer are limited to 0.1% w/w to 3% w/w when dryblended with PVC composition and yet exhibit satisfactory biodegradability.

In some examples, the solid appetizer can further include a polysaccharide. The polysaccharide can be selected from starch, cellulose, arabinoxylans, chitin, chitosan, pectins, xanthan gum, dextran, welan gum, gellan gum, diutan gum, guar gum, fenugreek gum, galactomannan, and pullulan, other polysaccharides known to persons skilled in the art, thermoplastic preparations thereof, and/or mixtures thereof. In some examples, the polysaccharide includes nanostarch and/or a nanostarch compound, as described herein. In some examples, the solid appetizer can include about 20% w/w to about 70% w/w of the polysaccharide. In some examples, the solid appetizer can include about 20% w/w to about 50% w/w of the polysaccharide. In some examples, the solid appetizer can include about 30% w/w of the polysaccharide. Additionally, in some examples, when the end-product optical clarity and transparency is important, the solid appetizer include about 1% w/w to about 20% w/w of the polysaccharide.

In some examples, the solid appetizer can further include an organic filler. The organic filler can be selected from wood fiber, saw dust, rice shells, nut shells, coffee shells, other organic fillers known to persons skilled in the art, and mixtures thereof. In some examples, the solid appetizer can include about 20% w/w to about 70% w/w of the organic filler. In some examples, the solid appetizer can include about 20% w/w to about 50% w/w of the organic filler. In some examples, the solid appetizer can include about 30% w/w of the organic filler. In other examples, the solid appetizer can include about 0% w/w to about 5% w/w of the organic filler.

In some examples, both liquid nanostarch booster and/or solid appetizer can further include one or more of a monosaccharide, a disaccharide and an oligosaccharide. The one or more of a monosaccharide, a disaccharide and an oligosaccharide can be selected from glucose, fructose, sucrose, glycerin, erythritol, threitol, arabitol, xylitol, ribitol, mannitol, sorbit, sorbitol, galactitol, galactose, iditol, volemitol, nonitol, isomalt, maltitol, lactitol, myo-inositol, other saccharides known to persons skilled in the art, and mixtures thereof. In some examples, the one or more of a monosaccharide, a disaccharide and an oligosaccharide includes sucrose. In some examples, the liquid nanostarch booster and/or solid appetizer includes about 3% w/w to about 15% w/w of the one or more of a monosaccharide, a disaccharide and an oligosaccharide. In some examples, the liquid nanostarch booster and/or solid appetizer includes about 5% w/w to about 10% w/w of the one or more of a monosaccharide, a disaccharide and an oligosaccharide.

If, for example, a mostly low molecular weight monosaccharide is chosen, it can be added as a component to the liquid booster. With a higher molecular weight oligosaccharide, it can be melt-mixed with the solid appetizer. The consideration here is mechanistic, to achieve optimal handling and delivery, along with thermal stability during extrusion.

In some examples, both liquid nanostarch booster and/or solid appetizer can further include a surfactant. The surfactant can be selected from glycerol monostearate (GMS), glycerol distearate (GDS), sorbitol monostearate (SMS), sorbitol distearate (SDS), polysorbate-20, polysorbate-40, polysorbate-60, polysorbate-80, sodium stearate, 4-(5-dodecyl) benzenesulfonate, docusate (dioctyl sodium sulfosuccinate), alkyl ether phosphates, benzalkaonium chloride (BAC), perfluorooctanesulfonate (PFOS), other surfactants known to persons skilled in the art, and mixtures thereof. In some examples, liquid nanostarch booster and/or solid appetizer can further include about 0.1% w/w to about 15% w/w of the surfactant. In some examples, about 1% w/w to about 10% w/w of the surfactant included. In some examples, liquid nanostarch booster and/or solid appetizer can further include about 6% w/w of the surfactant.

One consideration is the melting temperature of the surfactant. If the surfactant has a low melting temperature so that it is liquid at room temperature (like polysorbate-20), it can be added as a component to the liquid booster. If the surfactant has a melting temperature over 60° C. (like GMS), it can be added to the solid appetizer. In some examples, small and larger starch may be preblended with GMS at 80° C., so that GMS melts and coats the starch, thus improving its thermal stability and improving its compatibility with the rest of ingredients.

In some examples, the solid appetizer can include PBAT, PHA, nanostarch compound, sucrose, and processing aid. In a specific example, the solid appetizer can include: about 25% w/w of PBAT; about 25% w/w of PHA; about 30% w/w of nanostarch compound; about 10% w/w of sucrose; and about 10% w/w of processing aid.

In some examples, the solid appetizer can include PBAT, PHA, PBS, nanostarch compound, galactomannan polysaccharide, GMS, and GMO (glycerol monooleate). In a specific example, the solid appetizer can include: about 21% w/w of PBAT; about 7% w/w of PHA; 28% w/w of PBS; about 31% w/w of nanostarch compound; about 7% w/w of galactomannan polysaccharide; about 7% w/w of GMS; and about 1.4% w/w of GMO.

The inventors further recognize that chlorine and hydrochloride may be released during a biodegradation process of PVC resin, and that soft salts of chlorine are essential nutrients to plants. An addition of inorganic fillers able to bind with chlorine and hydrochloride can form plant nutrients and may further improve the quality of biomass remaining after the biodegradation process is complete. The inventors have developed some examples of the solid appetizer containing inorganic fillers, which can bind with chlorine and hydrochloride forming plant nutrients.

Thus, in some examples, the solid appetizer can further include an inorganic filler. The inorganic filler can be selected from calcium carbonate, clay, kaolin, glass fiber, glass beads, talc, wollastonite, iron ore byproducts, other minerals known to persons skilled in the art, and mixtures thereof. In some examples, the solid appetizer includes about 5% w/w to about 60% w/w of the inorganic filler.

In some examples, the use of inorganic fillers is not desirable because they will generally reduce clarity. In other examples, the use of inorganic fillers is advantageous. For example, to prepare a film with a strongly tinted blue color, a lot of pigment must be added, which increases the price and can make extrusion more difficult due to lubricants contained in the plasticizer. If a small amount of calcium carbonate or titanium dioxide is added together with the blue pigment, the inorganic additive can allow the pigment to show a stronger effect, so that less pigment addition is required.

Using liquid nanostarch booster and solid appetizer described herein, the inventors have experimented with various plasticized PVC compositions. All exemplary experimental specimens biodegraded in simulated aerobic composting conditions, with at least 90% of bioavailable carbon converted to carbon dioxide within 180 days, depending on the thickness of the specimen, degree of plasticization, and the content of the liquid nanostarch booster and the solid appetizer (ranging from 0.5% to 5%).

Thus, in accordance with an aspect of the present disclosure, a biodegradable plasticized PVC composition can be formulated with liquid nanostarch booster and solid appetizer. In some examples, the biodegradable plasticized PVC composition can include about 0.5% w/w to about 5% w/w of the liquid nanostarch booster and solid appetizer, and about 95% w/w to about 99.5% w/w of the plasticized PVC composition. In examples with a non-biodegradable PVC polymer as the carrier polymer, the biodegradable plasticized PVC composition can include more of the liquid nanostarch booster to ensure adequate biodegradability, for example, about 5% w/w to about 10% w/w of the liquid nanostarch booster and solid appetizer and about 90% w/w to about 95% w/w of the non-biodegradable PVC polymer.

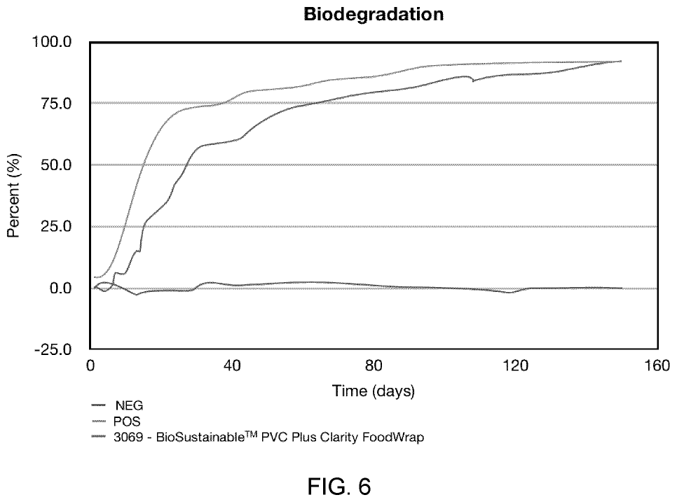

One exemplary plasticized PVC composition successfully tested that exhibited good biodegradation included 0.21% w/w of PBAT, 0.28% w/w of PBS, 0.07% w/w of PHA, 0.31% w/w of nanostarch compound, 0.07% w/w of fenugreek gum (galactomannan, a polysaccharide with mannose backbone with galactose side groups), 0.5% w/w of stearic acid, 0.4% w/w of calcium stearate, 0.1% w/w of PE wax, 0.07% w/w of GMS, 1.4% w/w of GMO, 5.5% w/w of ESBO, 4.1% w/w of DOTP, 13.8% w/w of DOA, 2.8% w/w high molecular weight adipate ester plasticizer, and 70.6% w/w of lubricated and heat stabilized PVC resin. The biodegradable plasticized PVC composition, which can be used for overwrap applications, was extruded using regular blown film extrusion equipment at BUR (blow up ratio) 5:1 into a 16 μm thick film. The film samples were tested at simulated aerobic composting conditions according to ASTM D5338. After 32 days, 56.3% biodegradation was recorded, and after 150 days, 92.2% biodegradation achieved. The test data after 150 days are shown in Table 3, and the biodegradation % is illustrated in FIG. 6.

TABLE 3

| | | | | 3069 - |
|---|---|---|---|---|
| | | | | BioSustainable ™ |
| | | | | PVC Plus |
| | | | | Clarity |
| | Inoculum | Negative | Positive | FoodWrap |
| Cumulative Gas | 1525.5 | 1522.4 | 9993.4 | 21142.3 |
| Volume (mL) | | | | |
| Percent CO₂ (%) | 67.7 | 63.0 | 82.6 | 85.1 |
| Volume CO₂ (mL) | 1033.0 | 958.6 | 8249.6 | 17993.6 |
| Mass CO₂ (g) | 2.03 | 1.88 | 16.20 | 35.34 |
| Sample Mass (g) | 1,000 | 10 | 10 | 20 |
| Theoretical | 0.0 | 8.6 | 4.2 | 9.9 |
| Sample Mass (g) | | | | |
| Biodegraded | 0.55 | 0.51 | 4.42 | 9.64 |
| Mass (g) | | | | |
| Percent Biode- | | −0.5 | 91.6 | 92.2 |
| graded (%) | | | | |
| Adjusted Percent | | −0.5 | 100.0 | 100.7 |
| Biodegraded (%) | | | | |

The aerobic biodegradation test according to ASTM D5338 requires knowing the content of bioavailable carbon in the test specimen. Due to complexity of multi-component recipe of plasticized PVC provided, an analytical test determining the elemental content of C (Carbon), N (Nitrogen), H (Hydrogen), S (Sulphur) for the exemplary plasticized PVC composition was performed using 2400 CHNS Organic Elemental Analyzer, and its results are shown in table 4.

TABLE 4

| Sample | C % wt | H % wt | N % wt | S % wt |
|---|---|---|---|---|
| Biosustainable ™ | | | | |
| PVC Plus Clarity | 49.26 ± | 7.055 ± | 0.395 ± | 0.635 ± |
| FoodWrap | 0.05 | 0.065 | 0.115 | 0.035 |
| (16mic film) | | | | |

In accordance with a further aspect of the present disclosure, methods of preparing biodegradable plasticized PVC compositions can include the following steps: (i) preparation of liquid nanostarch booster by (a) preparation of maleated nanostarch compound, and (b) dissolution of maleated nanostarch compound in plasticizer; (ii) preparation of solid appetizer as a pelletized compound via melt-blending extrusion; (iii) dryblending of PVC compositions with high-speed mixing of (a) PVC suspension resin mixed with heat stabilizing and lubricating package, (b) liquid nanostarch booster, (c) plasticization package, and (d) solid appetizer with processing aid and fillers; and (iv) extruding the PVC composition to obtain the biodegradable plastic material. In some examples, the method can include a preparatory step of hot blending at 80° C. of the nanostarch compound with a surfactant (like GMS) to improve the thermal stability, compatibility and dry-flow of nanostarch compound. In some examples, the method can include extruding the biodegradable plasticized PVC material in the form of a film, sheet, or any other finished continuous or discrete items.

While the above description provides examples of one or more compositions and methods, it will be appreciated that other compositions and/or methods may be within the scope of the accompanying claims.

1. A compostable plasticized polyvinyl chloride (PVC) composition, comprising:
a liquid preparation comprising a nanostarch compound; and
a solid appetizer material,
wherein the nanostarch compound comprises nanostarch with a particle size in a range of about 40 to about 500 nm,
wherein the nanostarch compound comprises small-size regular starch with a particle size in a range of about 2 to about 13 μm, and
wherein the nanostarch compound comprises large-size regular starch with a particle size in a range of about 10 to about 70 μm.

2. The composition of claim 1, wherein:
the nanostarch compound comprises nanostarch with an average particle size of about 100 nm; and
the nanostarch compound has about 1% w/w to about 50% w/w of the nanostarch.

3. (canceled)

4. The composition of claim 2, wherein:
the small-size regular starch comprises waxy rice starch with an average particle size of about 5.5 μm; and
the nanostarch compound has about 10% w/w to about 90% w/w of the small-size regular starch.

5. The composition of claim 4, wherein:
the large-size regular starch comprises potato starch with an average particle size of about 36 μm; and
the nanostarch compound has about 10% w/w to about 90% w/w of the large-size regular starch.

6. The composition of claim 1, wherein the liquid preparation comprises at least a portion of the nanostarch compound dissolved in at least one plasticizer.

7. The composition of claim 6, wherein at least a portion of the nanostarch compound is maleated for compatibility with the at least one plasticizer.

8. The composition of claim 7, wherein the at least one plasticizer is selected from epoxidized soya bean oil (ESBO), dinormalhexyl phthalate (DnHP), diisoheptyl phthalate (DIHP), diheptyl phthalate (DnHP), di (2-ethylhexyl) phthalate (DEHP), diheptylnonyl phthalate (DnHNP), dinormaloctyldecyl phthalate (DNODP), diheptylnonylundecyl phthalate (DnHNUP), diisononyl phthalate (DINP), dinonyl phthalate (DNP), dinormalnonyl phthalate (DnNP), disodecyl phthalate (DIDP), dinormalnonyldecylundecyl phthalate (DnNDUP), dinonylundecyl phthalate (DnNUP), diundecyl phthalate (DUP), diisoundecyldodecyl phthalate (DUDP), ditridecyl phthalate (DTDP), di (2-ethylhexyl) teraphthalate (DOTP), butylbenzyl phthalate (BBP), dioctyl adipate (DOA), diheptylnonyl adipate (DnHNA), Di (2-ethylhexyl) adipate (DEHA), diisononyl adipate (DINA), diisodecyl adipate (DIDA), triheptylnonyl trimellitate (TnHNTM), tri (2-ethylhexyl) trimellitate (TOTM), triisononyl trimellitate (TINTM), di (2-ethylhexyl) sebacate (DOS), di (2-ethylhexyl) azelate (DOZ), and mixtures thereof.

9. The composition of claim 1, comprising about 0.5% w/w to about 5% w/w of the nanostarch compound and the solid appetizer material.

10. The composition of claim 1, wherein the solid appetizer material comprises a portion of the nanostarch compound.

11. The composition of claim 1, wherein the solid appetizer material comprises a biodegradable polymer selected from poly (butylene adipate) (PBA), poly (butylene adipate-co-butylene terephthalate) (PBAT), poly (butylene succinate) (PBS), poly (butylene succinate-co-butylene adipate) (PBSA), poly (butylene terephthalate) (PBT), polyhydroxybutyrate (PHB), polyhydroxy-butylhexanoate (PHBH), polydioxanone (PDO), poly (glycolic acid) (PGA), poly (vinyl alcohol) (PVOH), polylactic acid (PLA), poly-epsiloncaprolactone (PCL), poly (limonene carbonate) (PLC), polyhydroxyalkanoate (PHA), polyhydroxyvalerate (PHV), polyhydroxy-butyratevalerate (PHBV), copolymers or derivatives thereof, and mixtures thereof, and the solid appetizer material has about 30% w/w to about 80% w/w of the biodegradable polymer.

12. (canceled)

13. The composition of claim 1, wherein the solid appetizer material comprises a polysaccharide selected from starch, cellulose, arabinoxylans, chitin, chitosan, pectins, xanthan gum, dextran, welan gum, gellan gum, diutan gum, guar gum, fenugreek gum, galactomannan, and pullulan, thermoplastic preparations thereof, and mixtures thereof, and the solid appetizer material has about 20% w/w to about 70% w/w of the polysaccharide.

14. (canceled)

15. The composition of claim 1, wherein the solid appetizer material comprises an organic filler selected from wood fiber, saw dust, cellulose, rice shells, nut shells, coffee shells, and mixtures thereof, and the solid appetizer material has about 20% w/w to about 70% w/w of the organic filler.

16. (canceled)

17. The composition of claim 1, wherein at least one of the nanostarch compound and the solid appetizer material comprises one or more of a monosaccharide, a disaccharide and an oligosaccharide selected from glucose, fructose, sucrose, glycerin, erythritol, threitol, arabitol, xylitol, ribitol, mannitol, sorbit, sorbitol, galactitol, galactose, iditol, volemitol, nonitol, isomalt, maltitol, lactitol, myo-inositol, and mixtures thereof, and the solid appetizer material has about 3% w/w to about 15% w/w of the one or more of a monosaccharide, a disaccharide and an oligosaccharide.

18-19. (canceled)

20. The composition of claim 1, wherein at least one of the nanostarch compound and the solid appetizer material comprises a surfactant selected from glycerol monostearate (GMS), glycerol distearate (GDS), sorbitol monostearate (SMS), sorbitol distearate (SDS), polysorbate-20, polysorbate-40, polysorbate-60, polysorbate-80, sodium stearate, 4-(5-dodecyl) benzenesulfonate, docusate (dioctyl sodium sulfosuccinate), alkyl ether phosphates, benzalkaonium chloride (BAC), and perfluorooctanesulfonate (PFOS), and mixtures thereof, and the solid appetizer material has about 0.1% w/w to about 15% w/w of the surfactant.

21. (canceled)

22. The composition of claim 1, wherein the solid appetizer material comprises an inorganic filler selected from calcium carbonate, clay, kaolin, glass fiber, glass beads, talc, wollastonite, iron ore byproducts, and mixtures thereof, and the solid appetizer material has about 5% w/w to about 60% w/w of the inorganic filler.

23. (canceled)

24. The composition of claim 1, wherein the solid appetizer material comprises:
about 25% w/w of PBAT;
about 25% w/w of PHA;
about 30% w/w of nanostarch compound;
about 10% w/w of sucrose; and
about 10% w/w of processing aid.

25. The composition of claim 1, wherein the solid appetizer material comprises:
about 21% w/w of PBAT;
about 7% w/w of PHA;
about 28% w/w of PBS;
about 31% w/w of nanostarch compound;
about 7% w/w of galactomamman polysaccharide;
about 7% w/w GMS; and
about 1.4% w/w GMO.

26. The composition of claim 1, comprising about 0.21% w/w of poly (butylene adipate-co-butylene terephthalate) (PBAT), about 0.28% w/w of poly (butylene succinate) (PBS), about 0.07% w/w of polyhydroxyalkanoate (PHA), about 0.31% w/w of nanostarch compound, about 0.07% w/w of fenugreek gum, about 0.5% w/w of stearic acid, about 0.4% w/w of calcium stearate, about 0.1% w/w of polyethylene wax, about 0.07% w/w of glycerol monostearate (GMS), about 1.4% w/w of glycerol monooleate (GMO), about 5.5% w/w of epoxidized soya bean oil (ESBO), about 4.1% w/w of di (2-ethylhexyl) terephthalate (DOTP), about 13.8% of dioctyl adipate (DOA), about 2.8% w/w high molecular weight adipate ester plasticizer, and about 70.6% w/w of lubricated and heat stabilized PVC resin.

27. A method of preparing a biodegradable polyvinyl chloride (PVC) material, comprising:
providing a liquid preparation comprising a nanostarch compound;
providing a solid appetizer material;
providing a PVC resin;
dryblending the liquid preparation, the solid appetizer material and the PVC resin to form a PVC composition; and
extruding the PVC composition to obtain the biodegradable plastic material.

28-43. (Canceled)

44. The method of claim 27, wherein the nanostarch compound comprises nanostarch with a particle size in a range of about 40 to about 500 nm, small-size regular starch with a particle size in a range of about 2 to about 13 μm, and large-size regular starch with a particle size in a range of about 10 to about 70 μm.
